(19) United States
(12) Patent Application Publication
(10) Pub. No.: US 2024/0349657 A1
(43) Pub. Date: Oct. 24, 2024

(54) Container and System to Direct Plant Root Growth

(71) Applicant: Hatem Hannawa, Farmington Hills, MI (US)

(72) Inventor: Hatem Hannawa, Farmington Hills, MI (US)

(21) Appl. No.: 18/138,308

(22) Filed: Apr. 24, 2023

(51) Int. Cl. A01G 9/02

(52) U.S. Cl. CPC A01G 9/02

(57) ABSTRACT

In at least one embodiment, there is disclosed a plant container and plant container system with a conical or frustoconical shape in its interior space that directs the growth of seedling roots toward the peripheral areas of the container. The arrangement reduces the amount of soil medium needed for the container as well as the amount of water, fertilizer to optimize plant growth.

### TECHNICAL FIELD

Containers for plants are often disposable and often have a specific shape to facilitate storage, bulk purchasing and easy removal of the plant for transplanting into a garden. Many times, these containers have an inverted trapezoidal, conical or frustoconical shape from top to bottom, so the greatest area for water absorption is at the container top/opening, and the narrowest part at the container bottom is where the plant roots proliferate, and the excess water drains through openings in the bottom of the container. The inverted trapezoidal, conical or frustoconical shape economizes on soil media and has an effect of forcing plant roots to ball or grow in a conical or frustoconical configuration from the top to the bottom of the container. But such plant containers have not been entirely satisfactory or economical for feeding, watering and transplanting of such potted plants. One reason is the horticulturalist has no idea exactly where the roots in such containers are intertwined or “balled”, thereby requiring the watering and fertilization of the entire volume of the soil media. This may result in excess fertilization and excess watering and excess costs incurred in caring for the plant.

There is a need for a plant container or plant container system that directs/crop steers the growth of plant roots into configurations that economize on watering and fertilization costs. Such a plant container or plant container system must be economical to manufacture, simple to use and may be used retroactively with existing containers.

There is further need for a plant container or plant container system to maximize harvest yields of fruits, vegetables, herbs, and spices.

There is a further need for a plant container or plant container system that reduces the amount of soil or medium required to stabilize the plant.

There is a further need for a plant container or plant container system that reduces the amount of feeding, watering and application of nutrients during cultivation process.

There is a further need for a planter container or plant container system configured to direct/crop steer the roots of a plant to move directly to the feeding bed(s) of the container.

These and other advantages will be apparent upon a reading of the specification that follows.

### SUMMARY

In at least one embodiment, the disclosure relates to a plant container system that is comprised of a shaped form, such as an inverted trapezoidal form or a cone, or a frustoconical structure, that may be placed in a corresponding plant container before soil media is introduced. The shaped insert is configured in such a way as to not interfere with water drainage openings in the bottom of the container. The shaped insert is sized so that it may be completely placed in the container with sufficient space so that it may be completely covered with soil media to a sufficient depth to permit a seedling to be planted in the media. The plant may be placed in the media covering the top of the shaped insert in the container. The shaped insert reduces the amount of soil media necessary to fill the container for use. In addition, the shaped insert crop steers/directs the plant roots to ball or grow around the insert, and not randomly ball up in soil media in the container. Since the user (horticulturalist) understands the shape of the insert, he/she fertilizes and waters those portions of soil media where the roots are steered/directed to grow. This will result in reduced fertilizing and watering needs. In addition, the targeted application of water and fertilizer will increase fruit, vegetable, spice and herb yields.

In another embodiment, the disclosure relates to a formed plant container system, such as by injection molding or other suitable manner, whereby a plant container is formed with a shape, such as a trianguloid, trapezoidal, cone or a frustoconical form in the interior of the container extending from the bottom of the container toward the top of the container. The shape is formed in the bottom of the container and is of less height than the container itself. The shape is of such height relative to the container height so that there is sufficient space between the shape and the container top to be covered by media for a sufficient depth as to permit a plant to be inserted in media over the formed shape. The formed shape does not interfere with the water drainage holes in the planter bottom surface. The trapezoidal, cone or frustoconical shape provides a number of advantages to the horticulturalist user. For example, the roots of the plant in the container are directed/crop steered toward the periphery of the container. The horticulturalist then knows where the roots are and directs water and fertilizer toward the roots. The shape form also allows the horticulturalist to use less soil than a container without the interior trapezoidal, conical or frustoconical shape. Less soil use also benefits the horticulturalist because a container having the shaped form with less soil is of lighter weight that a similarly sized container with soil but without the shaped form. Cost savings, such as less soil media, reduced fertilizer and water usage are realized as well.

In yet another embodiment, the disclosure is related to a tray of multiple plant containers formed with a root growth directing/crop steering shaped form in the container interior. The shaped form is sized to be smaller than the bottom of the container and is oriented in the container so as to not interfere with soil drainage openings in the container. The tray of such containers are joined at border regions with material that is easy to separate. In this regard, perforated lines for easy separation of containers is one such way. The tray plant containers so configured may be formed by injection molding.

In yet another embodiment, the disclosure is related to a light-weight plant container, or a tray of such containers, formed with a root growth directing/crop steering shaped forms to direct or steer the roots of a plant away from the center of the container interior and toward exterior walls of the container to minimize random root balling and permit the user to understand exactly where the plant roots are growing. The horticulturalist may then direct water and fertilizer to those areas of known root presence and thereby maximize fruit yield and vegetable size as well as spice or herb yield.

Regardless of whether the container includes a trapezoidal, frustoconical or conical insert, or is formed with such a trapezoidal, conical or frustoconical structure in the container interior, the horticulturist will realize certain advantages with the systems as described. These advantages include less soil used per container, reduced water and fertilizer use than required or experienced by using conventional plant containers. In addition, the containers when in use are lighter weight than conventional planters when in use because of the reduced soil volume being used in the containers as will be described herein. Additionally, a plant cultivated in the container/container system of this application will have increased fruit, vegetable, spice and herb yields for a given amount of fertilizer and water than plants cultivated in similarly sized container without the shaped form or insert.

These and other improvements and advantages will become apparent upon a reading of the disclosure and reference to the drawings.

### BRIEF DESCRIPTION OF DRAWINGS

FIG. 1A is a side view of a conical insert for the container system according to one embodiment of the disclosure;

FIG. 1B is a side view of a frustoconical insert for the container system according to one embodiment of the disclosure.

FIG. 1C is a side view of a trianguloid insert for the container system according to one embodiment of the disclosure.

FIG. 2A is a cut-away side view of a plant container system showing a conical shaped insert therein according to one embodiment of the disclosure.

FIG. 2B is a cut-away side view of a plant container system showing a frustoconical shapes insert therein accordingly to one embodiment of the disclosure.

FIG. 3 is a top perspective view of a plant container system of FIGS. 2A-2B showing the orientation of the insert on the bottom surface of the container.

FIG. 4 is a cutaway side view of a container having a conical shaped form integral with the bottom of the container showing its construction.

FIG. 5 is cutaway side perspective view of the container of FIG. 4.

FIG. 6A is a top view of a plurality of plant containers as seen in FIG. 4 joined together as a matrix at their respective boundary areas.

FIG. 6B is a cutaway side view of the plant containers of FIG. 6A.

FIG. 7 is a cutaway side view of the plant containers of FIGS. 2A-5 showing the distribution of a plant root ball.

### DETAILED DESCRIPTION

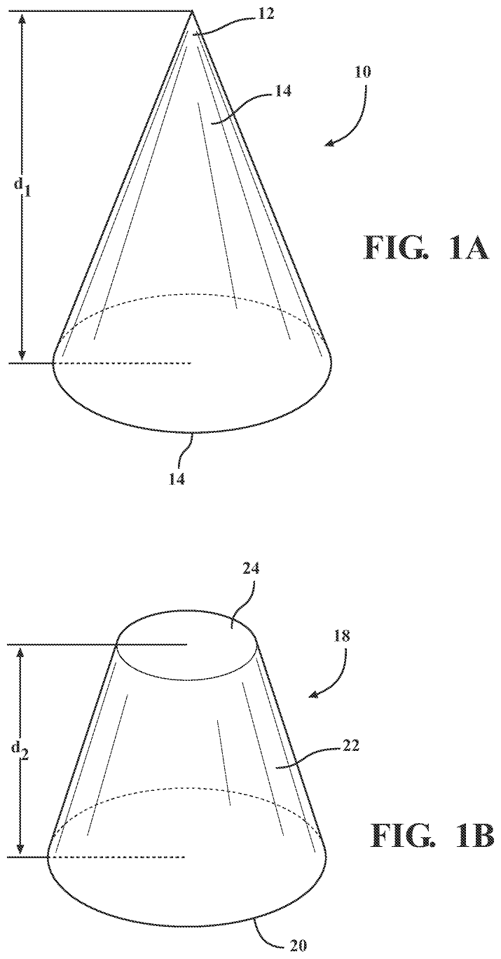

Turning now to the drawings wherein like numbers refer to like structures, FIGS. 1A and 1B and 1C show different shapes that may be used as inserts to steer plant roots in a container system accordingly to one embodiment of the disclosure. While the phrase conical or frustoconical are used, it is understood that any shape that steers the roots to the plant seeding is contemplated by these terms. By this it is understood that any shape that is wider at its bottom that at its top can serve to steer plant roots as described in this disclosure. Accordingly, it is to be understood that trianguloid, pyramidal, rhomboidal etc., structures are included in the terms conical and frustoconical.

FIG. 1A shows a conical insert 10 that has a vertex 12 and a base 14 separated from the vertex by a sidewall 16 extending from the perimeter of the base to the vertex such that the height of the form is d1 as measured from the base to the vertex. Similarly, FIG. 1B shows a frustoconical insert 18 with a base 20 and sidewall 22 extending from the base to the frustrum 24 so the height of the form is d2 as measured from the base to the frustrum 24. FIG. 1C is a representation of a trianguloid insert having a vertex 13, a base 15 and a height measured as d4.

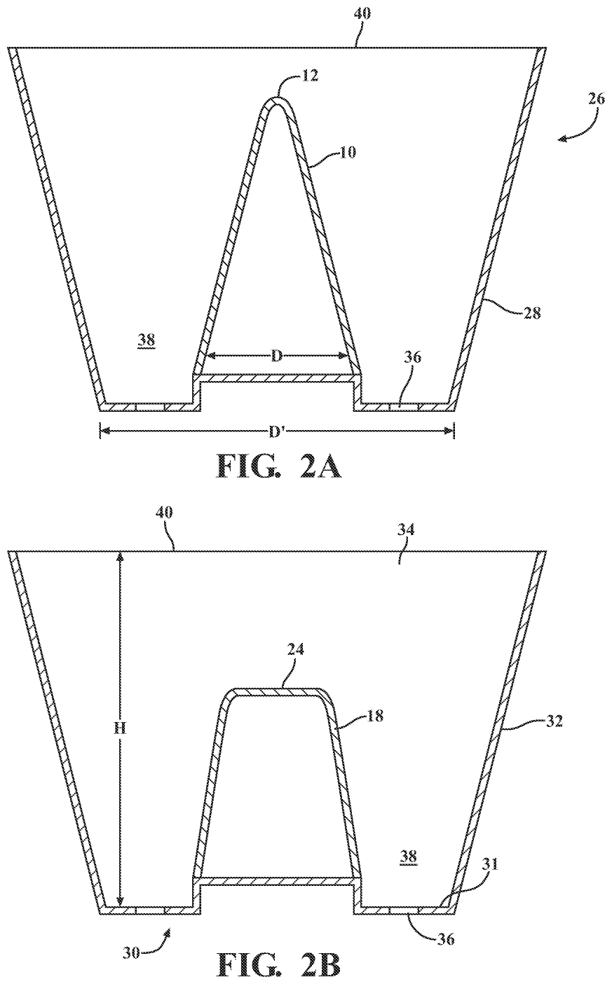

FIGS. 2A and 2B are a cutaway side view of a container system 26 with an insert therein. FIG. 2A shows a conical insert 10. FIG. 2B shows a frustoconical insert. In both FIGS. 2A and 2B, the container system includes a container 28 with a bottom 30 having sidewalls 32 extending from the container bottom perimeter 31 to an opening 34 define a height “H” of the container. The bottom surface has drainage openings 36 to permit the drainage of water from the container. In FIG. 2A, a conical insert is placed into the container to steer the plant roots toward the peripheral areas 38 of the container. In FIG. 2B, a frustoconical shape is shown in the container. The base of the conical or frustoconical insert is of smaller diameter than the diameter of the contender. Also note the distance d1 and d2 are both less than the height H such that the insert vertex or frustum is below the opening edge 40 by a sufficient amount so that when the container system is filled with soil medium, a plant seedling may be planted above the insert.

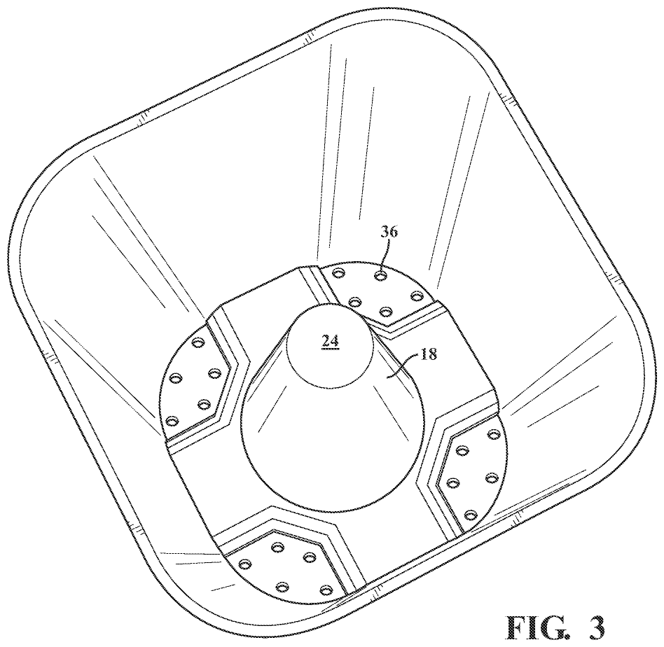

FIG. 3 is a top perspective view of the container system of FIGS. 2A-2B showing the insert in place in the bottom of the container. While conical insert or shape is depicted, one of ordinary skill in the art understands that any shape of insert is contemplated as long as it crop steers plant roots in a desired direction. As previously stated, the insert or shape has a base that is smaller than the diameter D of the container. The insert or shape is oriented centrally in the container bottom and does not interfere with the drainage openings (holes) in the bottom of the container.

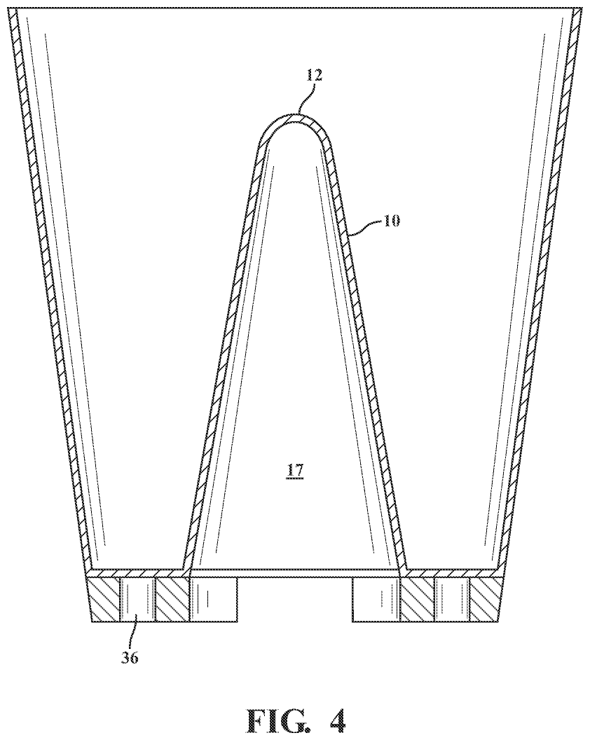

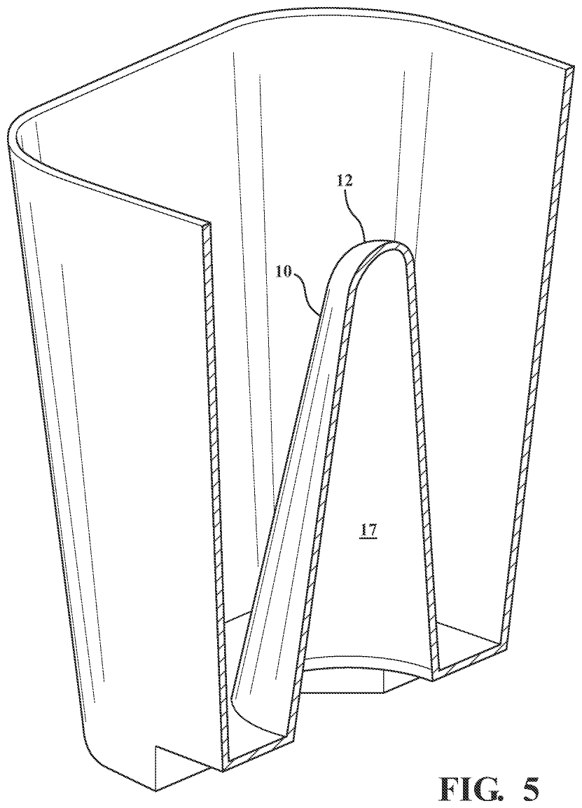

FIGS. 4 and 5 relate to a plant container 60 according to another embodiment of the disclosure. Sidewalls 62 and sidewall insert 64 are as described above with respect to the embodiment of FIGS. 1-3. In this embodiment, the conical or frustoconical insert is not separate from and inserted into the plant container 60. Rather the shaped conical or frustoconical form 66 is integral at its base 70 with the container itself and formed in the container bottom 68 and 17 is a space that is the interior of the injection molded insert shape. The form 66 has a vertex 72 and sidewalls 74 extending substantially unbroken from the vertex to the base. The vertex is positioned below the container opening 84 a sufficient distance such that when the container is filled with soil medium, a seedling plant may be placed in the soil over the vertex. As the seedling grows it sends roots into the soil medium 73 which are directed by the form to the peripheral areas 76 of the container. As is the case with the system described in FIGS. 1-3, as the roots are directed to the peripheral area, the horticulturalist is able to direct water and nutrients to those peripheral areas where the roots are balled. This results in savings because the entire interior space need not be watered or fertilized. In addition, increase yields in fruits and herb size may be expected. Excess water is allowed to drain through aperture 60.

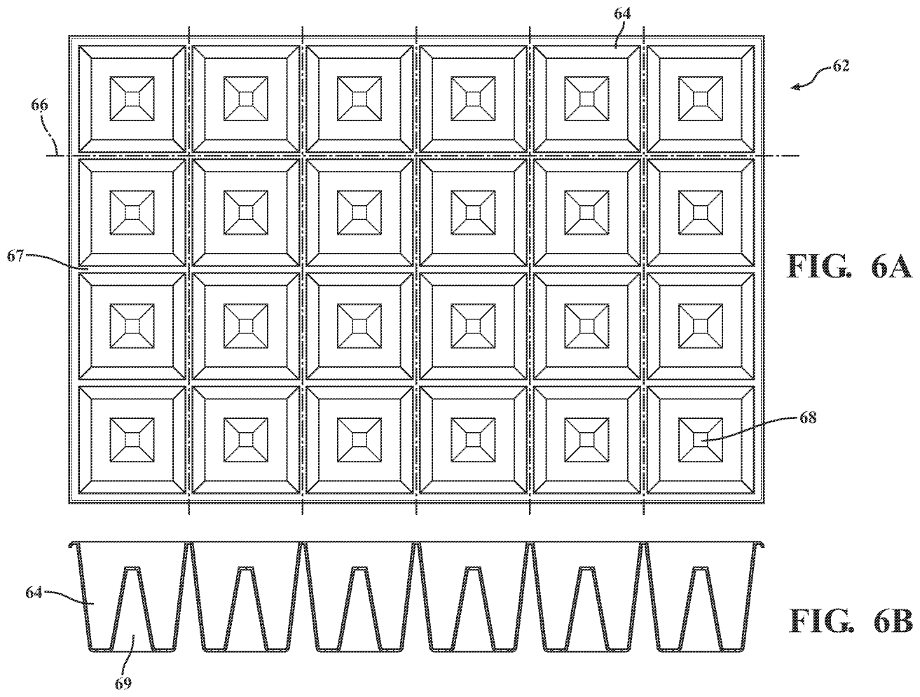

FIG. 6A shows a plurality of containers as described in FIGS. 1-5 joined together for easy manufacture, handling and transport. These container sheets 62 may be formed by injection molding. The individual containers 64 may be easily disengaged or snap broken at boundary portions 66 from the other containers in the tray along perforations 67. While the container sheets are shown with a shape 68 already in place in the container, it is also understood the container sheet can be formed without the shapes which may be inserted by the user at a later time. FIG. 6B is a cutaway side view of the containers in FIG. 6A showing frustoconical form 69 in the plant container 64 for crop steering the roots of a plant.

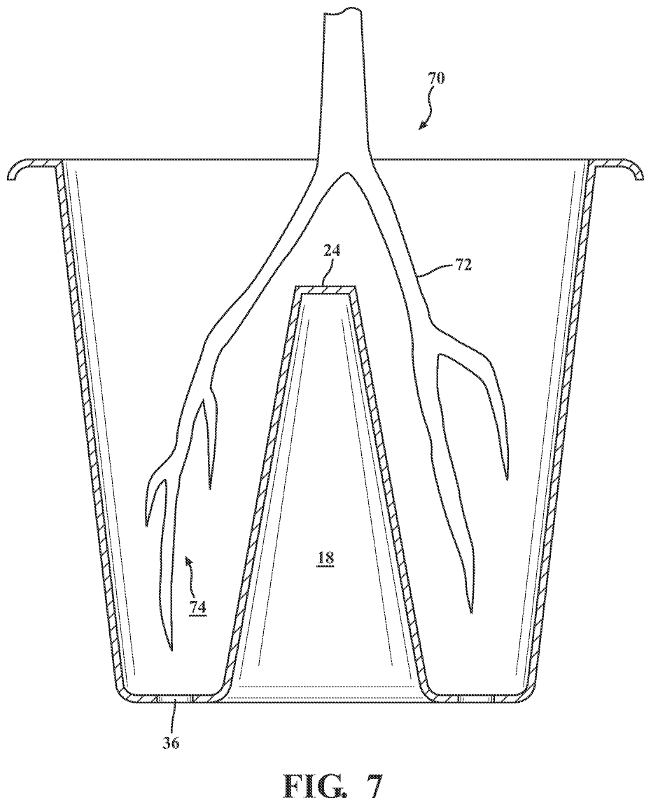

FIG. 7 depicts an illustration of how a plant 70 grows in the container with the conical or frustoconical insert or shaped form. Roots 72 are crop steered by the shaped insert to form root ball 74 in the peripheral areas of plant container. The direction of the roots to the peripheral areas as described presents advantages to the horticulturalist. Directing the roots to the peripheral areas by use of the insert or shape requires less soil potting material in the container than a conventional plant container of similar size but without the shape or insert. The user or horticulturalist will understand the shape or the insert crop steers the growth of the plant roots toward the peripheral section of the container and the horticulturalist need water and fertilize only where the roots are. Knowing where the roots are growing or “balled” permits targeted application of fertilizers, nutrients and water, thereby reducing the amount of fertilizer, nutrients and water required. It is believed the use of the crop steering insert will increase the plant yield. The horticulturalist will use less soil medium 73 or material and less water and fertilizer when growing plants. This will reduce the financial cost to grow plants in the containers as described. In addition, the plant may be easily removed from the described plant container because the insert allows root balls to form only in the peripheral area and not randomly and haphazardly in the container such as is seen in conventional plant containers without the insert.

Referring generally to the entirety of above description and material incorporated by reference, the text and drawings shall be interpreted as illustrative rather than limiting. Changes in detail or structure may be made without departing from the present disclosure. Various embodiments are described above to provide a general understanding of the overall structure and function of the system and method of operation. Particular configurations, assemblies, or components and functions described with respect to one embodiment may be combined, in whole or in part, with those of other embodiments. Well-known operations, components, and elements such as simple attachment devices have not been described in detail so as not to obscure the embodiments described in the specification. While processes, systems, and methods may be described herein in connection with one or more steps in a particular sequence, such methods may be practiced with the steps in a different order, with certain steps performed simultaneously, with additional steps, and/or with certain described steps omitted.

Words referring to relative position (upper, lower, upward, downward, top, bottom, above, below, vertical, horizontal, etc.) are only used to aid understanding of the disclosure, and do not create limitations, particularly as to the position, orientation, or use of embodiments. Similarly, words describing connections (attached, connected supported, fitted, etc.) are to be construed broadly and may include intermediate members between a connection of elements and relative movement between elements. As such, these references do not necessarily imply that two elements are directly connected/coupled and in fixed relation to each other. The use of “e.g.” in the specification is to be construed broadly and is used to provide non-limiting examples of embodiments of the disclosure, and the disclosure is not limited to such examples. Uses of “and” and “or” are to be construed broadly (e.g., to be treated as “and/or”). For example, and without limitation, uses of “and” do not necessarily require all elements or features listed, and uses of “or” are intended to be inclusive.

I claim:

1. A plant container system, comprising;
a. a bottom surface; said bottom surface including a central area and peripheral area surrounding said central area; said peripheral area extending from said central area to a perimeter of said bottom surface; said peripheral area further equipped with drainage openings arranged along said peripheral area of said bottom surface;
b. a side wall with a first and second end, said side wall having a height and extending substantially unbroken from said first end to said second end; said side wall attached at said first end to said bottom surface to form an opening opposite said bottom surface; said sidewall height and said bottom surface form an interior space; said sidewall forming an exterior surface of a container;
c. an insert located on the bottom surface of the container, said insert having a height less than the height of the container, said insert having a conical or frustoconical shape.

2. The plant container system of claim 1, wherein the sidewalls extend from said container bottom perimeter to form an interior, wherein the opening has a larger dimension than the bottom surface.

3. The plant container system of claim 1, wherein the bottom further includes at least one opening below the bottom surface to permit water to drain away from the container.

4. A plant container, comprising;
a. a bottom surface; said bottom surface including a central area and peripheral area surrounding said central area; said peripheral area extending from said central area to a perimeter of said bottom surface; said peripheral area further equipped with drainage openings arranged along said peripheral area of said bottom said perimeter of said bottom surface;
b. a side wall having a height and extending substantially unbroken from said bottom surface to form an opening opposite said bottom surface; said sidewall height and said bottom surface form an interior space and an exterior of a container; and
c. an insert integral with the bottom surface and extending along the periphery of the bottom surface and extending at least partially the height of the sidewall wherein the insert is substantially conical or frustoconical.

5. The plant container of claim 4, wherein the sidewalls extend from said container bottom perimeter to form a frustoconical interior, wherein the opening has a larger dimension than the bottom surface.

6. The plant container of claim 4, wherein said sidewalls extend from said perimeter of said bottom surface.

7. The plant container of claim 4, wherein said bottom surface is equipped with a raised portion for the insert and at least one recessed portion for the drainage openings.

8. The plant container of claim 4, wherein the bottom surface is located between said first and second end of said sidewall.

9. The plant container of claim 4, wherein the sidewalls further include at least one opening below the bottom surface to permit water to drain away from the container.
